(19) United States
(12) Patent Application Publication
(10) Pub. No.: US 2006/0213603 A1
(43) Pub. Date: Sep. 28, 2006

(54) Multi-layer ceramic electronic component and production method thereof

(76) Inventors: Kwi-Jong Lee, Seoul (KR); Jeong-Ho Yoon, Seongnam-si (KR); Jae-Woo Joung, Suwon-si (KR)

Correspondence Address: STANZIONE & KIM, LLP, 919 18TH STREET, N.W., SUITE 440, WASHINGTON, DC, 20006, US

(21) Appl. No.: 11/330,285

(22) Filed: Jan. 12, 2006

(30) Foreign Application Priority Data
Mar. 24, 2005 (KR) 2005-24328

(51) Int. Cl. C03B 29/00; B05D 7/00; B05D 5/00; B05D 1/02; B05D 5/12

(52) U.S. Cl. 156/89.12; 156/89.16; 427/421.1; 427/256; 427/79

(57) ABSTRACT

The present invention relates to a multi-layer ceramic electronic component and production method thereof. According to the present invention, a method for manufacturing a multi-layer ceramic electronic component comprises forming a dielectric film; and forming a dielectric sheet simultaneously printed with an internal electrode and a dielectric between electrodes formed on the same plate with the internal electrode by spraying ink for the electrode and ink for the dielectric employing a plurality of inkjet print heads on the dielectric film. Thus, the multi-layer ceramic capacitor of the present invention resolves height difference by printing simultaneously a dielectric and an internal electrode.

### CROSS-REFERENCE TO RELATED APPLICATIONS

This application claims the benefit of Korean Patent Application No. 2005-24328 filed with the Korea Industrial Property Office on Mar. 24, 2005, the disclosure of which is incorporated herein by reference.

### BACKGROUND OF THE INVENTION

1. Field of the Invention

The present invention relates to an electronic component, particularly a multi-layer ceramic capacitor and a manufacturing method thereof.

2. Description of the Related Art

Multi-layer ceramic capacitor (MLCC: Multi-Layer Ceramic Capacitor) is an electronic component of laminated capacitors with a number of layers and performs various functions such as blockage of DC signals, bypassing, resonant frequency, and the like. Needs for smaller and lightweight multi-layer ceramic capacitor are increasing with the development of handheld communication terminals. According to the conventional technology, a multi-layer ceramic capacitor has been prepared by printing an electrode paste on a green sheet via a printing method such as screen printing, flexo printing, and gravure printing, cutting after layering a plurality of the green sheets, firing at a high temperature, coating an external electrode, firing, and coating.

Since an internal electrode is printed on the sheet of the printed dielectric, when dielectric sheets are layered, it causes height difference due to difference in thickness of the internal electrode. Referring to FIG. 1, it shows an internal electrode 110 and a dielectric 120, which form height difference a due to difference in thickness of the internal electrode. In order to reduce the height difference is it proposed to reduce the thickness of the internal electrode but it is limited to reduce it.

FIG. 2 illustrates a method for eliminating difference in height produced by internal electrodes of a conventional multi-layer ceramic capacitor. Referring to FIG. 2, after printing an internal electrode 110 on a dielectric film 120, dielectric slurry 130 is filled between internal electrodes.

However, this method has several drawbacks. First, there is a problem associated with a composition of the dielectric slurry 130. It is required to use a different dielectric slurry from solvents used for dielectric film 120 and internal electrode 110 in order to print a new material on the preprinted/dried portion. That is, a binder composition of the dielectric slurry 130 should be different from that of the dielectric film 120 to select a proper solvent which does not dissolve each other. Thus, when the dielectric slurry 130 is used, it can be difficult to select appropriate binder and solvent. Second, when a binder composition used for the dielectric slurry 130 is different from that for the dielectric film 120, it deteriorates adhesion with each other. Alternatively, adhesion between different binder compositions is less than that between same binder compositions so that adhesion between the dielectric slurry 130 and the dielectric film 120 is deteriorated during layering. As a result, it causes breaks of products or cracks between layers during polishing or calcinations. Third, it requires an additional printer to fill between internal electrodes. This additional printer should have opposite pattern to that used for printing the internal electrode and it can thus require an additional pattern recognition program to form accurate pattern.

### SUMMARY OF THE INVENTION

It is therefore an object of the present invention to provide a multi-layer ceramic electronic component to resolve height difference by printing simultaneously a dielectric and an internal electrode and production method thereof.

Additional aspects and advantages of the present general inventive concept will be set forth in part in the description which follows and, in part, will be obvious from the description, or may be learned by practice of the general inventive concept.

It is another object of the present invention to provide a multi-layer ceramic electronic component to improve adhesion between dielectric sheets during layering and production method thereof.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates difference in height produced by internal electrodes of a conventional multi-layer ceramic capacitor.

FIG. 2 illustrates a method for eliminating difference in height produced by internal electrodes of a conventional multi-layer ceramic capacitor.

FIG. 3 illustrates a method for simultaneously printing a dielectric and an electrode by an inkjet printing according to a preferred embodiment of the present invention.

FIG. 4 illustrates a dielectric and an electrode simultaneously printed by an inkjet printing according to a preferred embodiment of the present invention.

FIG. 5 is a flow chart illustrating a process for printing simultaneously dielectrics and electrodes by an inkjet printing according to the first embodiment of the present invention.

FIG. 6 illustrates a dielectric and an electrode simultaneously printed by an inkjet printing according to the second embodiment of the present invention.

FIG. 7 is a flow chart illustrating a process for printing simultaneously dielectrics and electrodes by an inkjet printing according to the second embodiment of the present invention.

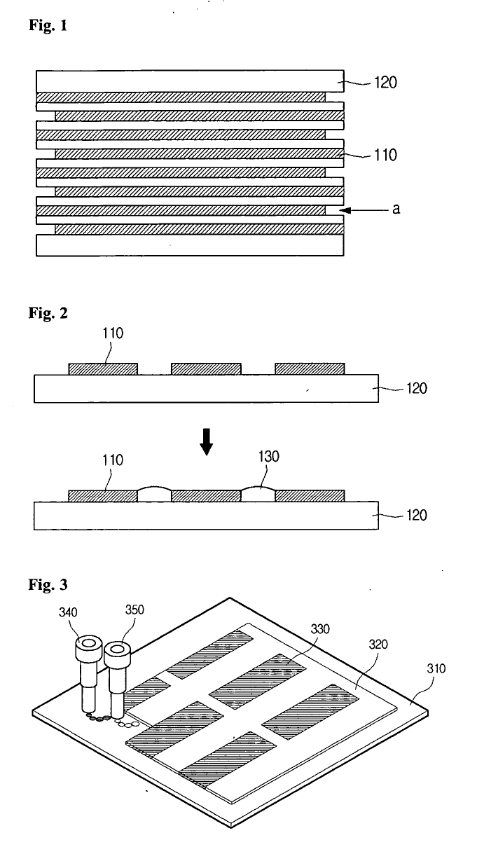

320: dielectric
330: internal electrode
340: inkjet print head for the internal electrode
50: inkjet print head for the dielectric

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Here, the method for manufacturing a multi-layer ceramic electronic component may further comprise laminating and compressing the dielectric sheets; cutting the dielectric sheets according to a predetermined pattern; and calcining the dielectric sheets.

Here, a cutting line to cut said dielectric sheets is parallel to the internal electrode and divides the dielectric between electrodes into two.

Further, according to another preferred embodiment of the present invention, it is provided a device for manufacturing a multi-layer ceramic electronic component comprising an inkjet print head for the internal electrode spraying ink for the internal electrode and an inkjet print head for the dielectric spraying ink for the dielectric, wherein the inkjet print head for the internal electrode and the inkjet print head for the dielectric print simultaneously internal electrodes and dielectrics, respectively.

Further, according to another preferred embodiment of the present invention, it is provided a method for manufacturing a multi-layer ceramic capacitor comprising: forming a dielectric film by utilizing dielectric slurry; and printing simultaneously an internal electrode and a dielectric between electrodes formed on the same plate with the internal electrode by spraying ink for the electrode and ink for the dielectric employing a plurality of inkjet print heads on the dielectric film.

Further, according to another preferred embodiment of the present invention, it is provided a method for manufacturing a multi-layer ceramic capacitor comprising: forming a dielectric film by spraying ink for the dielectric employing an inkjet print head; and printing simultaneously an internal electrode and a dielectric between electrodes formed on the same plate with the internal electrode by spraying ink for the electrode and ink for the dielectric employing a plurality of inkjet print heads on the dielectric film.

Here, the plurality of inkjet print heads comprise an inkjet print head for the internal electrode spraying ink for the internal electrode and an inkjet print head for the dielectric spraying ink for the dielectric

Here, the inkjet print head for the electrode and said inkjet print head for the dielectric spray inks by moving integrally or by moving independently according to its own operation signals.

Further, according to another preferred embodiment of the present invention, it is provided a multi-layer ceramic electronic component prepared by the method for manufacturing the above-described multi-layer ceramic electronic component.

Hereinafter, embodiments of the multi-layer ceramic electronic component and manufacturing method thereof according to the present invention will be described in more detail with accompanying drawings, and in describing drawings, same or corresponding member will have same reference number and repeated description will be omitted throughout whole drawings.

Further, the present invention can be generally applicable to multi-layer ceramic electronic components using layered ceramics and will describe general theory of the multi-layer ceramic capacitor prior to the detailed description of the preferred embodiments of the present invention.

### Embodiments

A multi-layer ceramic capacitor comprises dielectric, internal electrode, and external electrode. The dielectric is an external body of the multi-layer ceramic capacitor and made from ceramic materials so that it is called as “ceramic body”. Typical electric is BaTiO3 (Barium Titanate, BT) which has a high conductivity at an ambient temperature. A calcination temperature of BT powder dielectric is about 1250° C.

The internal electrode is positioned in the dielectric and conductive materials. Example of the internal electrode includes palladium (Pd), nickel (Ni), copper (Cu), and the like of which each melting temperature is 1555° C., 1452° C., 1083° C., respectively. The external electrode is conductive material to connect the multi-layer ceramic capacitor with an external power. Since the external electrode is designed for a component for surface mount, it not only connects with an external power but also performs that solder adheres well thereto when it is mounted on the substrate.

FIG. 3 illustrates a method for simultaneously printing a dielectric and an internal electrode by an inkjet printing according to a preferred embodiment of the present invention. Referring to FIG. 3, each inkjet print head for the internal electrode 340 and inkjet print head for the dielectric 350 form internal electrodes 330 and dielectrics 320 on a carrier film 310 according to a predetermined pattern.

The inkjet print head for the internal electrode 340 and the inkjet print head for the dielectric 350 spray ink for the internal electrode and ink for the dielectric, respectively. The ink for the internal electrode may comprise metal powder such as palladium (Pd), nickel (Ni), copper (Cu), tungsten (W), molybdenum (Mo), and the like, binder and solvent and the ink for the dielectric may comprise BT powder, binder, and solvent. Here, the ink for the internal electrode and the ink for the dielectric may use different solvents from each other which are not miscible so that when they are printed simultaneously, they are not miscible.

Here, the term simultaneous printing of the internal electrode and the dielectric by an inkjet printing means not only spraying ink for the electrode and ink for the dielectric at the same time but also printing the internal electrode and the dielectric according to a predetermined program and pattern by employing a plurality of inkjet print heads. Thus, the internal electrode and the dielectric can be printed simultaneously or with the same pass. For example, referring to FIG. 3, the inkjet print head for the internal electrode 340 and the inkjet print head for the dielectric 350 move integrally on the carrier film 310 to simultaneously print the internal electrode and the dielectric. Here, the inkjet print head for the internal electrode 340 stops moving and the inkjet print head for the dielectric 350 only sprays ink for the dielectric at the portion where only dielectric is printed.

Such inkjet print head for the internal electrode 340 and inkjet print head for the dielectric 350 may be a head of inkjet print device to spray inks. For example, the inkjet print device may comprise a supporting part to support the device, an inkjet print head printing internal electrode and dielectric by spraying inks on a carrier film according to a predetermined pattern, a moving means moving the inkjet print head on the carrier film 310, and a circuit part performing program which is for the inkjet print head to spray inks according to a predetermined pattern.

Here, the inkjet print head for the internal electrode 340 and the inkjet print head for the dielectric 350 can spray by moving integrally. That is, the internal electrode and the dielectric are printed at the same pass according to a predetermined pattern. When the head moves at the same time, the internal electrode and the dielectric can be printed according to a predetermined pattern with controlling spraying time and amount from each head. According to another embodiment of the invention, the inkjet print head for the internal electrode 340 and the inkjet print head for the dielectric 350 can spray by moving independently according to its own operation signals. That is, each head has one device or a separate device so that it receives a different signal by a different program and operates corresponding to the signal.

Further, according to the present invention, various methods including a build-up method which comprises forming a dielectric sheet on a carrier film by an inkjet printing and then forming dielectric sheets by laminating the dielectric sheets or forming a dielectric sheet by an inkjet printing and then forming dielectric sheets repeatedly on the formed dielectric sheet by an inkjet printing.

According to the described above, since the internal electrode 330 and the dielectric 320 are printed at the same time by an inkjet printing, there is no height difference between the internal electrode 330.

Figures illustrating the multi-layer ceramic electronic component and its manufacturing method have been described above. Hereinafter the multi-layer ceramic electronic component and its manufacturing method will be described in more detail based on particular embodiments of the invention. The embodiments of the present invention are divided into two of which one is a method for forming internal electrodes and dielectrics between the electrodes around the internal electrode at the same plate on the pre-molded dielectric film by an inkjet printing, and the other is a method for forming internal electrodes and dielectrics between the electrodes around the internal electrode at the same plate on the formed dielectric film by an inkjet printing.

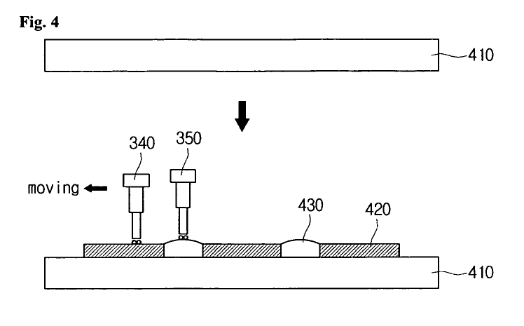

FIG. 4 illustrates the internal electrode and the dielectric between electrodes formed simultaneously on the pre-molded dielectric film by an inkjet printing according to the first embodiment of the present invention. Referring to FIG. 4, it illustrates a dielectric film 410 formed by utilizing slurry including dielectric powder, dispersant and binder and the internal electrode 420 and the dielectric between electrodes 430 are formed on the dielectric film 410 by the inkjet print head for the internal electrode 340 and the inkjet print head for the dielectric 350 at the next step.

The dielectric film 410 is formed by the conventional batch and casting process. Further, the internal electrode 420 and the dielectric between electrodes 430 are formed by ink for the internal electrode and ink for the dielectric sprayed according to a predetermined pattern by an inkjet print head. Here, ink used for the dielectric between electrodes 430 can include same or different binder and solvent used for the slurry of the dielectric film 410.

Here, each method for manufacturing a multi-layer ceramic capacitor can be performed diversely. For example, it can be prepared by laminating dielectric sheets simultaneously printed with the internal electrode 420 and the dielectric between electrodes 430 according to a predetermined pattern, compressing, and cutting. According to another embodiment of the present invention, it can be prepared by printing the internal electrode 420 and the dielectric between electrodes 430 with a chip unit, forming a dielectric film thereon, and printing repeatedly the internal electrode 420 and the dielectric between electrodes 430 thereon.

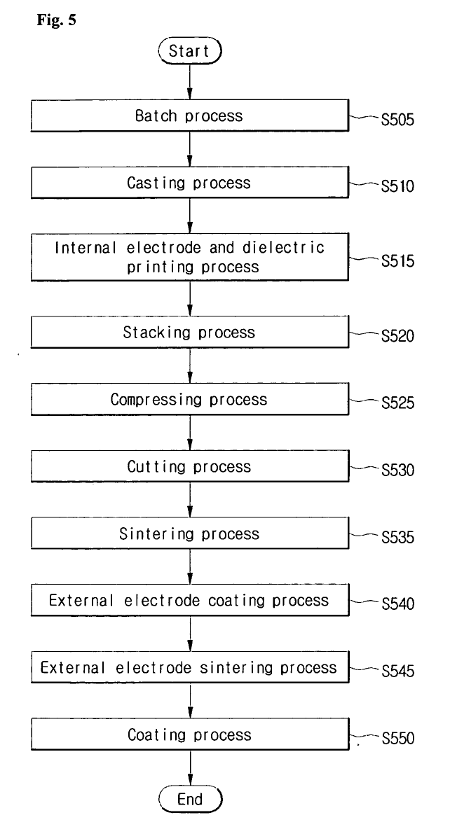

FIG. 5 is a flow chart illustrating a method for printing simultaneously the internal electrode and the dielectric between electrodes on a pre-molded dielectric film by an inkjet printing according to the first embodiment of the present invention.

At S505, slurry including dielectric powder, dispersant, and binder is prepared and at S510, the slurry is molded to form a film by utilizing a carrier film.

At S515, the internal electrode 330 and the dielectric 320 are printed on the molded dielectric film according to a predetermined pattern by using the inkjet print head for the internal electrode 340 and the inkjet print head for the dielectric 350.

At S520, the dielectric film printed with the internal electrode is laminated with a predetermined number, compressed at S525, ant cut with a chip unit at S530. At S535 the formed chips are calcined and coated electrically to connect an external electrode and the internal electrode at S540, and the external electrode is calcined at S545.

Here, the external electrode is coated prior to calcinations of metal powder for the internal electrode so that the dielectric powder and internal electrode metal powder can be calcined together. At S550, the desired multi-layer ceramic capacitor with a chip unit is prepared by a coating process.

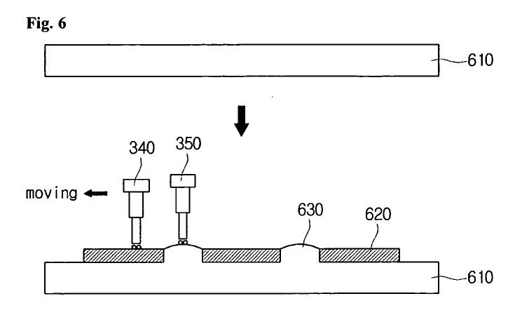

FIG. 6 illustrates a dielectric and an electrode simultaneously printed by an inkjet printing according to the second embodiment of the present invention. Referring to FIG. 6, it illustrates the dielectric film 610, the internal electrode 620, and the dielectric 630 between electrodes formed by the inkjet print head for the internal electrode 340 and the inkjet print head for the dielectric 350.

The dielectric film 610 is formed by an inkjet printing method, not a casting process according to the conventional technology. For example, the process comprises forming the dielectric film 610 by an inkjet printing and forming simultaneously the internal electrode 620 and the dielectric 630 between electrodes on the dielectric film 610. Here, the dielectric film 610 can be formed by the inkjet print head for the dielectric 350 as described above or by an additional inkjet print head for the dielectric film. Further, according to another embodiment, the process comprises forming the dielectric film 6 by dielectric slurry and forming simultaneously the internal electrode 620 and the dielectric 630 between electrodes on the dielectric film 610 by an inkjet printing when the dielectric film is dried by half.

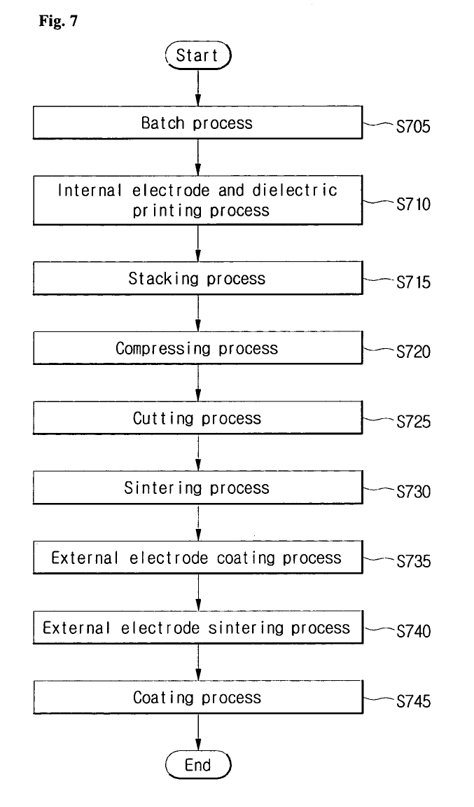

FIG. 7 is a flow chart illustrating a process for printing simultaneously dielectrics and electrodes by an inkjet printing according to the second embodiment of the present invention. The difference from the first embodiment is described in more detail.

At S705, a carrier film to be formed with the dielectric film 610, the internal electrode 620 and the dielectric 630 between electrodes is prepared and at S710, the dielectric film 610 is printed by inkjet print head for the dielectric 350 and the internal electrode 620 and the dielectric 630 between electrodes are printed by the inkjet print head for the internal electrode 340 and the inkjet print head for the dielectric 350. The dielectric film 610 can be formed as a separated step from the formation step of the internal electrode 620 and the dielectric 630 between electrodes or at the same step. Besides that, the other processes are the same as in the first embodiment.

Although the foregoing description details various embodiments of the invention, it will be appreciated that the embodiments are only examples of realizing the spirit of the invention, and that any changed or modified examples remain within the scope of the invention so long as they do not depart from the spirit of the invention.

### INDUSTRIAL APPLICABILITY

As described above, the multi-layer ceramic electronic component and manufacturing method thereof of the present invention resolves height difference by printing simultaneously the internal electrode and the external electrode.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method for manufacturing a multi-layer ceramic electronic component comprising:
forming a dielectric film; and
forming a dielectric sheet simultaneously printed with an internal electrode and a dielectric between electrodes formed on the same plate with the internal electrode by spraying ink for the electrode and ink for the dielectric employing a plurality of inkjet print heads on the dielectric film.

2. The method for manufacturing a multi-layer ceramic electronic component, further comprising:
laminating and compressing the dielectric sheets;
cutting the dielectric sheets according to a predetermined pattern; and
calcining the dielectric sheets.

3. The method for manufacturing a multi-layer ceramic electronic component of claim 2, wherein a cutting line to cut said dielectric sheets is parallel to the internal electrode and divides the dielectric between electrodes into two.

4. The method for manufacturing a multi-layer ceramic electronic component of claim 1, wherein said plurality of inkjet print heads comprises an inkjet print head for the internal electrode spraying ink for the internal electrode and an inkjet print head for the dielectric spraying ink for the dielectric.

5. The method for manufacturing a multi-layer ceramic electronic component of claim 4, wherein said inkjet print head for the electrode and said inkjet print head for the dielectric spray inks by moving integrally.

6. The method for manufacturing a multi-layer ceramic electronic component of claim 4, wherein said inkjet print head for the electrode and said inkjet print head for the dielectric spray inks by moving independently according to its own operation signals.

7. A multi-layer ceramic electronic component manufactured by the method for manufacturing a multi-layer ceramic capacitor of claim 1.

8. A multi-layer ceramic electronic component manufactured by the method for manufacturing a multi-layer ceramic capacitor of claim 2.

9. A multi-layer ceramic electronic component manufactured by the method for manufacturing a multi-layer ceramic capacitor of claim 3

10. A multi-layer ceramic electronic component manufactured by the method for manufacturing a multi-layer ceramic capacitor of claim 4.

11. A multi-layer ceramic electronic component manufactured by the method for manufacturing a multi-layer ceramic capacitor of claim 5.

12. A multi-layer ceramic electronic component manufactured by the method for manufacturing a multi-layer ceramic capacitor of claim 6.

13. A device for manufacturing a multi-layer ceramic electronic component comprising
an inkjet print head for the electrode spraying ink for the electrode; and
an inkjet print ink for the dielectric spraying ink for the dielectric,
wherein said inkjet print head for the electrode and said inkjet print head for the dielectric print simultaneously each internal electrode, external electrode, and dielectric.

14. The device for manufacturing a multi-layer ceramic electronic component of claim 13, wherein said inkjet print head for the electrode and said inkjet print head for the dielectric spray inks by moving integrally.

15. The device for manufacturing a multi-layer ceramic electronic component of claim 13, wherein said inkjet print head for the electrode and said inkjet print head for the dielectric spray inks by moving independently according to its own operation signals.

16. A method for manufacturing a multi-layer ceramic capacitor comprising:
forming a dielectric film by utilizing dielectric slurry; and
printing an internal electrode and a dielectric between electrodes formed on the same plate with the internal electrode by spraying ink for the electrode and ink for the dielectric employing a plurality of inkjet print heads on the dielectric film.

17. The method for manufacturing a multi-layer ceramic capacitor of claim 16, wherein said plurality of inkjet print heads comprises an inkjet print head for the internal electrode spraying ink for the internal electrode and an inkjet print head for the dielectric spraying ink for the dielectric.

18. The method for manufacturing a multi-layer ceramic capacitor of claim 17, wherein said inkjet print head for the electrode and said inkjet print head for the dielectric spray inks by moving integrally.

19. The method for manufacturing a multi-layer ceramic capacitor of claim 17, wherein said inkjet print head for the electrode and said inkjet print head for the dielectric spray inks by moving independently according to its own operation signals.

20. A method for manufacturing a multi-layer ceramic capacitor comprising:
forming a dielectric film by spraying ink for the dielectric employing an inkjet print head; and
printing simultaneously an internal electrode and a dielectric between electrodes formed on the same plate with the internal electrode by spraying ink for the electrode and ink for the dielectric employing a plurality of inkjet print heads on the dielectric film.

21. The method for manufacturing a multi-layer ceramic capacitor of claim 20, wherein said plurality of inkjet print heads comprise an inkjet print head for the internal electrode spraying ink for the internal electrode and an inkjet print head for the dielectric spraying ink for the dielectric.

22. The method for manufacturing a multi-layer ceramic capacitor of claim 21, wherein said inkjet print head for the electrode and said inkjet print head for the dielectric spray inks by moving integrally.

23. The method for manufacturing a multi-layer ceramic capacitor of claim 21, wherein said inkjet print head for the electrode and said inkjet print head for the dielectric spray inks by moving independently according to its own operation signals.
